(19) United States
(12) Patent Application Publication
(10) Pub. No.: US 2013/0098851 A1
(43) Pub. Date: Apr. 25, 2013

(54) ANTI-THEFT SOCKET RACK

(71) Applicant: CHIN KEN HSIAO, CHANGHUA COUNTY (TW)

(72) Inventor: CHIN KEN HSIAO, CHANGHUA COUNTY (TW)

(21) Appl. No.: 13/303,079

(22) Filed: Nov. 22, 2011

(30) Foreign Application Priority Data
Oct. 24, 2011 (TW) 100219977

(51) Int. Cl. A47B 81/00; E05B 73/00

(52) U.S. Cl. 211/4

(57) ABSTRACT

An anti-theft socket rack includes a base and a main board is perpendicularly connected to the base, and multiple separation plates extend perpendicularly from the base. Multiple spaces are defined between the base, the main board and the separation plates. Each space has an opening located opposite to the main board so as to receive sockets therein. At least one handle has a long board and two short boards which are pivotably connected to the base so that the long board closes the openings of the spaces when in a closed position. A covering plate extends from the long board and partially covers the spaces. An anti-theft unit includes a lug extending from each of the two short boards and a bolt extends through the lugs and is connected to the base.

### FIELD OF THE INVENTION

The present invention relates to a socket rack, and more particularly, to an anti-theft socket rack.

### BACKGROUND OF THE INVENTION

The sockets are one of the most convenient tools and there are different sizes of sockets available. The sockets are sold by a pack which includes a socket rack and the sockets are connected positioned to the rack. Some of the conventional socket racks have anti-theft feature which prevents people to open the rack and take the sockets without permission.

Taiwan Utility Model No. M322202, M326515 and M335362 show the anti-theft socket rack which carries only one socket. M315639 and M320343 show the anti-theft socket rack with multiple sockets positioned therein.

However, the conventional anti-theft socket racks require the customers to cut the anti-theft device so as to open the rack and take the sockets. In other words, once the anti-theft device is cut, it is no longer functional. The customers carry the sockets with the same socket pack to work, the sockets can also be stolen because of lack of the anti-theft device. Furthermore, the existed anti-theft devices are complicated and the molds for manufacturing the anti-theft devices are hard to be made and the cost for making the molds will be high.

The present invention intends to provide an anti-theft socket rack which improves the shortcomings mentioned above.

### SUMMARY OF THE INVENTION

The present invention relates to an anti-theft socket rack and comprises a base and a main board is perpendicularly connected to the base and located along the long axis of the base, and multiple separation plates extend perpendicularly from the base and are located along the short axis of the base. Multiple spaces are defined between the base, the main board and the separation plates. Each space has an opening located opposite to the main board so as to receive sockets therein. At least one handle has a long board and two short boards which are pivotably connected to the base so that the long board closes the openings of the spaces when in a closed position. A covering plate extends from the long board and partially covers the spaces. An anti-theft unit includes a lug extending from each of the two short boards and a bolt extends through the lugs and is connected to the base. The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the anti-theft socket rack of the present invention;

FIG. 2 is a perspective view to show the anti-theft socket rack of the present invention;

FIG. 3 is a side view to show that the handle is pivoted away from the base and the socket can be removed from the anti-theft socket rack of the present invention;

FIG. 4 is a cross sectional view of the anti-theft socket rack of the present invention;

FIG. 5 is a perspective view to show another embodiment of the anti-theft socket rack of the present invention;

FIG. 6 is a perspective view to show the embodiment of FIG. 5 of the anti-theft socket rack of the present invention, wherein the two handles are in closed positions;

FIG. 7 is a perspective view to show yet another embodiment of the anti-theft socket rack of the present invention, wherein the two handles are in closed positions, and

FIG. 8 is a perspective view to show the embodiment of FIG. 7 of the anti-theft socket rack of the present invention, wherein the two handles are in opened positions.

### DETAILED DESCRIPTION OF THE PREFERRED EMBODIMENT

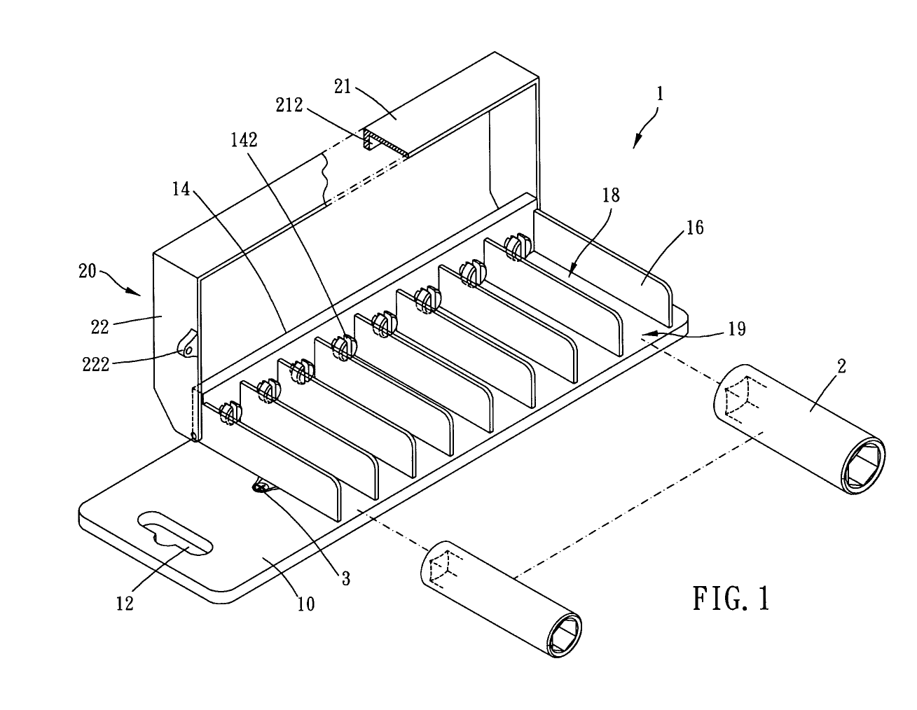

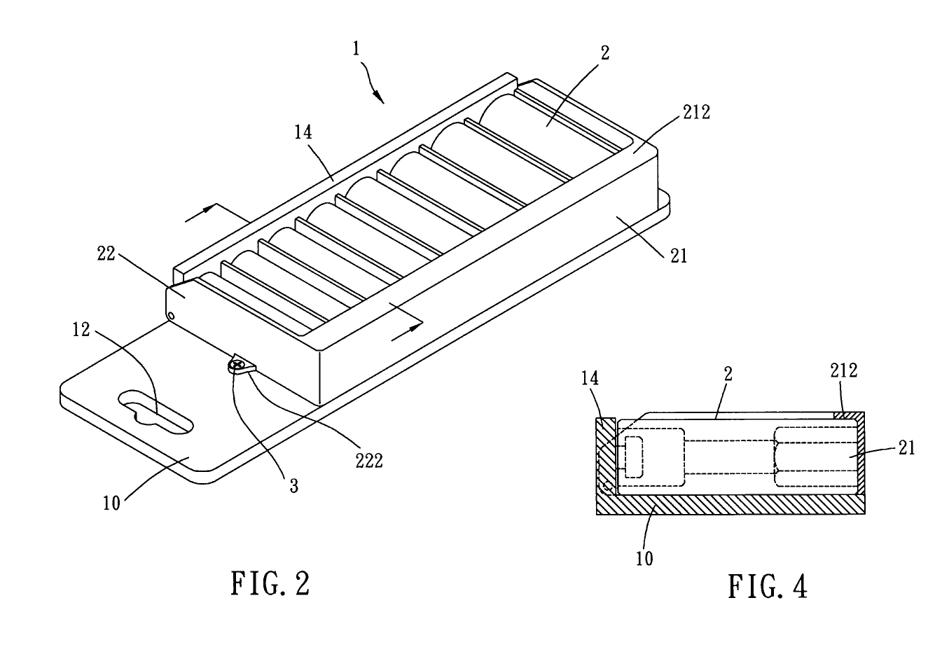

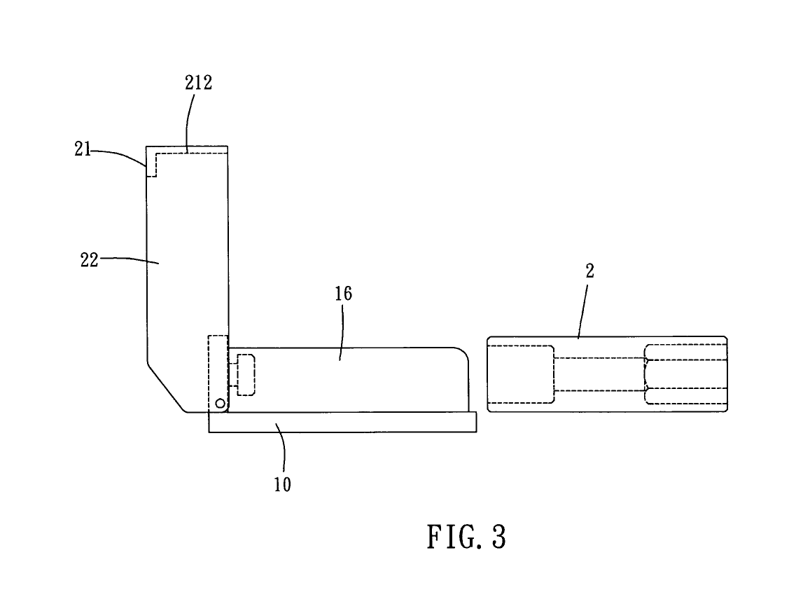

Referring to FIGS. 1 to 4, the anti-theft socket rack 1 of the present invention comprises a base 10 which is a board with a long axis and a short axis. A hanging hole 12 is defined through the base 10. A main board 14 is perpendicularly connected to the base 10 and located along the long axis and multiple separation plates 16 extend perpendicularly from the base 10 and is located along the short axis. Multiple spaces 18 are defined between the base 10, the main board 14 and the separation plates 16. Each space 18 has an opening 19 located opposite to the main board 14 so that sockets 2 is received in the spaces 18 via the openings 19. The main board 14 has engaging portions 142 which are located to face the spaces 18 respectively. The sockets 2 are engaged with the engaging portions 142 to be positioned. The engaging portions 142 each are composed of two semi-circular parts with a slit defined therebetween so as to provide proper resilient feature.

A handle 20 has a long board 21 located along the long axis thereof and two short boards 22 are located on two ends of the long board 21. The long board 21 closes the openings 19 of the spaces 18 when in a closed position. The two short boards 22 are pivotably connected to the base 10. Preferably, the two short boards 22 are pivotably connected to the separation plates 16 on the base 10 or the two short boards 22 are pivotably connected to the main board 14 on the base 10. The two short boards 22 and the main board 14 or the separation plates 16 may respectively have bosses and notches so as to be matched with each other. When the handle 20 is at the closed position, the long board 21 closes the openings 19 of the spaces 18 so that the sockets 2 do not slip off from the spaces 18. A covering plate 212 extends from the long board 21 and partially covers the spaces 18 when the handle is at the closed position. Therefore, the sockets 2 cannot be picked from the spaces 18. An anti-theft device is connected between the two short boards 22 and the base 10. The anti-theft device comprises two lugs 222 respectively located on the two short boards 22 and two bolts 3 extend through the two lugs 222 and are connected to the base 10.

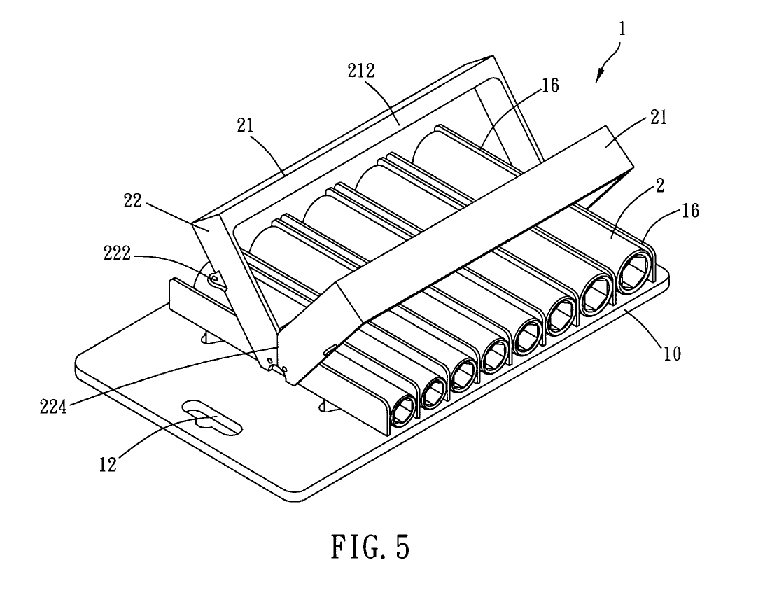

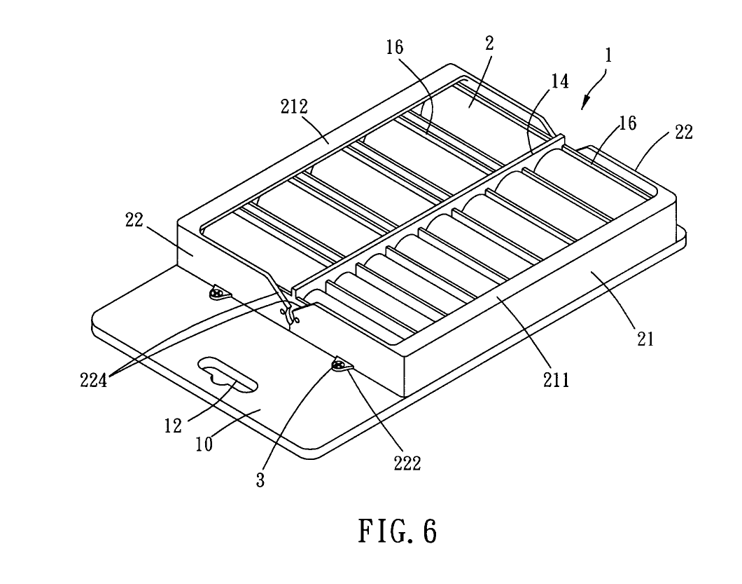

As shown in FIGS. 5 and 6 for the disclosure of another embodiment of the present invention and the embodiment is similar to the first embodiment. The main board 14 is located at the central portion of the base 10 so as to have two sets of recesses 18 located on two sides of the main board 14. There are two handles 20 and each of the handles 20 has its short boards 22 each have an inclined side 224. Therefore, when the two handles 20 are pivoted upward, as shown in FIG. 5, the two inclined sides 224 are in contact with each other and the two handles are in a V-shaped arrangement when viewed from either end of the base 10.

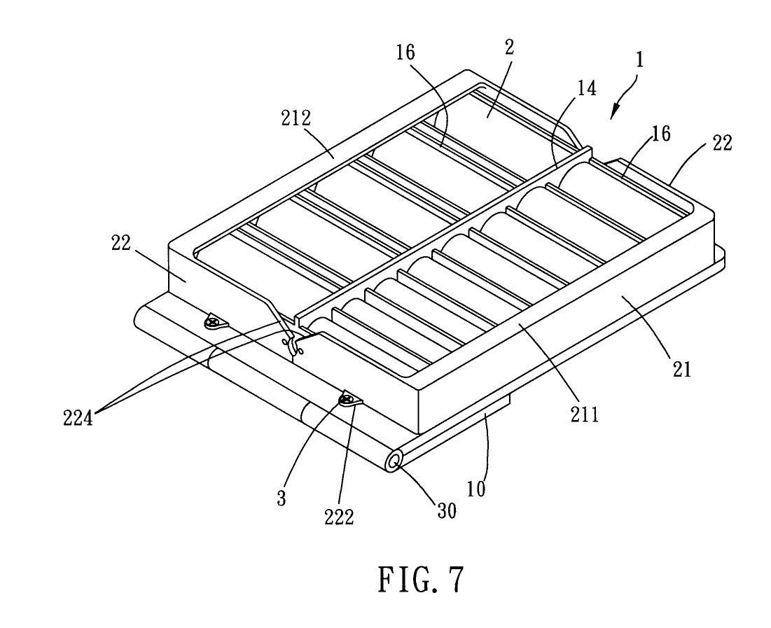

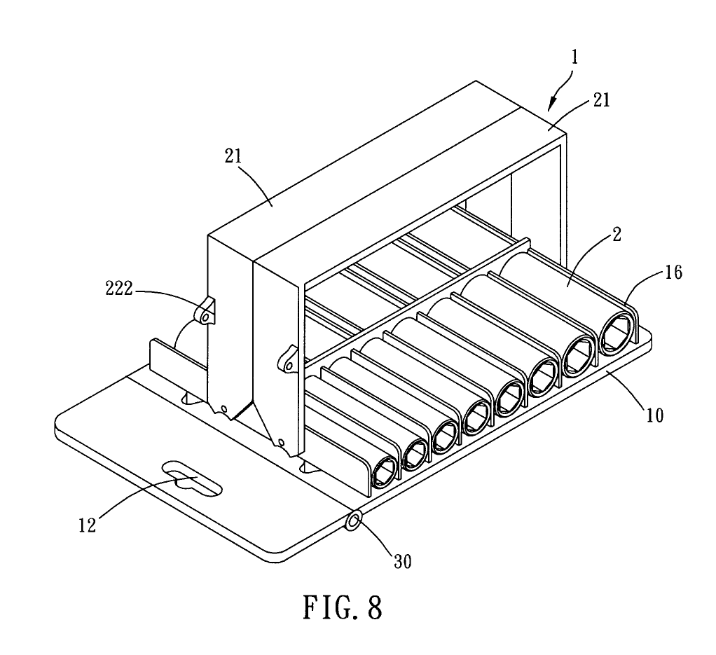

FIGS. 7 and 8 disclose yet another embodiment of the present invention and the embodiment is similar to the first embodiment. The difference is that the base 10 comprises a first board and a second board. The first board is located corresponding to the spaces 18. The first and second boards are pivotably connected to each other by a shaft 30 so that the two second board is pivotable relative to the first board. The second board can be pivoted and overlaps the bottom of the base 10 so that the length of the base 10 can be adjusted as needed. A positioning unit is located between the first board and the second board which is connected to the first board by the positioning unit. The positioning unit may comprise teeth or the positioning unit may comprise bosses and notches respectively defined in the first and second boards. Accordingly, when the second board is pivoted relative to the first board to a desired angular position, the bosses are engaged with the botches, or the teeth of the first and second boards are engaged with each other, such that the base 10 is supported at an angle relative to the table or desk. This inclination of the base 10 is convenient for the users to pick the sockets 2.

The structure of the anti-theft socket rack is simple and the handle 20 protects the sockets 2 in the spaces 18 from being stolen by the covering plate 212. Furthermore, the anti-theft unit can be used repeatedly by locking the bolts 3 through the lugs 222.

While we have shown and described the embodiment in accordance with the present invention, it should be clear to those skilled in the art that further embodiments may be made without departing from the scope of the present invention.

What is claimed is:

1. An anti-theft socket rack comprising:
a base being a board with a long axis and a short axis, a main board perpendicularly connected to the base and located along the long axis and multiple separation plates extending perpendicularly from the base and located along the short axis, multiple spaces defined between the base, the main board and the separation plates, each space having an opening located opposite to the main board, and
at least one handle having a long board located along a long axis thereof and two short boards located on two ends of the long board, the long board closing the openings of the spaces when in a closed position, the two short boards pivotably connected to the base, a covering plate extending from the long board and partially covering the spaces, an anti-theft device connected between the two short boards and the base.

2. The socket rack as claimed in claim 1, wherein the two short boards are pivotably connected to the separation plates on the base.

3. The socket rack as claimed in claim 1, wherein the two short boards are pivotably connected to the main board on the base.

4. The socket rack as claimed in claim 1, wherein the main board has engaging portions which are located to face the spaces respectively, the engaging portions are adapted to be connected with sockets.

5. The socket rack as claimed in claim 1, wherein the anti-theft device comprises two lugs respectively located on the two short boards and two bolts extend through the two lugs and are connected to the base.

6. The socket rack as claimed in claim 1, wherein the base has a hanging hole defined therethrough.

7. The socket rack as claimed in claim 1, wherein there are two handles pivotably connected to the base and each handle has an inclined side defined in the short boards thereof.

8. The socket rack as claimed in claim 1, wherein the base comprises a first board and a second board, the first board is located corresponding to the spaces, the first and second boards are pivotably connected to each other by a shaft.
